(19) United States
(12) Patent Application Publication
(10) Pub. No.: US 2008/0007640 A1
(43) Pub. Date: Jan. 10, 2008

(54) PHOTOELECTRIC CONVERSION CIRCUIT AND SOLID-STATE IMAGE-SENSING DEVICE USING IT

(75) Inventors: Takaaki Fuchikami, Kyoto-shi (JP); Masato Moriwake, Kyoto-shi (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/774,115

(22) Filed: Jul. 6, 2007

(30) Foreign Application Priority Data
Jul. 7, 2006 (JP) 2006-188009

(51) Int. Cl. H04N 5/335

(52) U.S. Cl. 348/301

(57) ABSTRACT

A photoelectric conversion circuit has: a photoelectric conversion element that produces a detection current commensurate with the amount of light received thereby; a capacitor having one end connected to one end of the photoelectric conversion element, the one end of the capacitor from which a terminal voltage commensurate with the integral of the detection current is drawn; and an amplifier that receives the terminal voltage of the capacitor and produces an amplified signal commensurate with the terminal voltage thus received. The photoelectric conversion circuit outputs a final optical signal (an output current) by using the amplified signal of the amplifier. As a current path that can serve as a charging/discharging path of the capacitor, the photoelectric conversion circuit includes only a current path along which the photoelectric conversion element is located. With this configuration, it is possible to enhance responsivity to light and improve the S/N ratio of a received optical signal by making the most of electric power obtained from a photoelectric conversion element.

This application is based on Japanese Patent Application No. 2006-188009 filed on Jul. 7, 2006, the contents of which are hereby incorporated by reference.

### BACKGROUND OF THE INVENTION

1. Field of the Invention

The present invention relates to photoelectric conversion circuits and to solid-state image-sensing devices using such photoelectric conversion circuits.

2. Description of Related Art

FIG. 5 is a circuit diagram showing an example of a conventional CMOS (complementary metal oxide semiconductor) photoelectric conversion circuit (a so-called CMOS sensor).

In the CMOS sensor shown in this figure, the anode of a photodiode 51 is connected to the ground, and the cathode thereof is connected to one end of a switch 54. The other end of the switch 54 is connected to one end of a capacitor 52, to the gate of an N-channel field-effect transistor 53, and to one end of a switch 55. The other end of the capacitor 52 is connected to the ground. The other end of the switch 55 is connected to a point to which a power supply voltage Vcc is applied. The drain of the transistor 53 is connected to a point to which the power supply voltage Vcc is applied. The source of the transistor 53 is connected to one end of a switch 56. The other end of the switch 56 is connected to a received optical signal output line 57.

When the CMOS sensor configured as described above is initialized, the switch 54 is turned off and the switches 55 and 56 are turned on. As a result of this switching control, the capacitor 52 is charged by a charging current iy passing through the switch 55, so that a terminal voltage Vc of the capacitor 52 rises to a predetermined initial voltage level (that is, a level at which the capacitor 52 is fully charged). As a result, the transistor 53 is reset to its initial state (full-on state), and an output current iz flowing through the received optical signal output line 57 rises to a maximum value.

After initialization of the CMOS sensor, when the photodiode 51 is exposed to light, the switch 54 is turned on and the switches 55 and 56 are turned off. As a result of this switching control, the capacitor 52 is discharged by a detection current ix commensurate with the amount of light received by the photodiode 51, so that the terminal voltage Vc of the capacitor 52 falls below the initial voltage level. As a result, depending on the amount of light received by the photodiode 51, the conductivity of the transistor 53 becomes lower than that observed in its initial state.

After the photodiode 51 is exposed to light, when the received optical signal is read, the switches 54 and 55 are turned off and the switch 56 is turned on. As a result of this switching control, the output current iz commensurate with the conductivity of the transistor 53 (that is, the amount of light received by the photodiode 51) is outputted through the received optical signal output line 57. This makes it possible to detect the amount of light received by the photodiode 51 based on a decrease in the output current iz.

Some examples of the configuration of the CMOS sensor are a configuration in which the anode of a photodiode is connected to a common ground (a so-called anode common type) and a configuration in which the cathode of the photodiode is connected to a common power supply point (a so-called cathode common type).

FIG. 6 is a circuit diagram showing another example of the configuration of a conventional CMOS photoelectric conversion circuit.

In the CMOS sensor shown in this figure, the cathode of a photodiode 61 is connected to a point to which a power supply voltage Vcc is applied, and the anode thereof is connected to one end of a switch 64. The other end of the switch 64 is connected to one end of a capacitor 62, to the gate of a P-channel field-effect transistor 63, and to one end of a switch 65. The other end of the capacitor 62 is connected to the ground. The other end of the switch 65 is connected to the ground. The drain of the transistor 63 is connected to the ground. The source of the transistor 63 is connected to one end of a switch 66. The other end of the switch 66 is connected to a received optical signal output line 67.

When the CMOS sensor configured as described above is initialized, the switch 64 is turned off and the switches 65 and 66 are turned on. As a result of this switching control, the capacitor 62 is discharged by a discharging current iy passing through the switch 65, so that a terminal voltage Vc of the capacitor 62 drops to a predetermined initial voltage level (that is, a ground voltage GND). As a result, the transistor 63 is reset to its initial state (full-on state), and an output current iz flowing through the received optical signal output line 67 rises to a maximum value.

After initialization of the CMOS sensor, when the photodiode 61 is exposed to light, the switch 64 is turned on and the switches 65 and 66 are turned off. As a result of this switching control, the capacitor 62 is charged by a detection current ix commensurate with the amount of light received by the photodiode 61, so that the terminal voltage Vc of the capacitor 62 rises above the initial voltage level. As a result, depending on the amount of light received by the photodiode 61, the conductivity of the transistor 63 becomes lower than that observed in its initial state.

After the photodiode 61 is exposed to light, when the received optical light is read, the switches 64 and 65 are turned off and the switch 66 is turned on. As a result of this switching control, the output current iz commensurate with the conductivity of the transistor 63 (that is, the amount of light received by the photodiode 61) is outputted through the received optical signal output line 67. This makes it possible to detect the amount of light received by the photodiode 61 based on a decrease in the output current iz.

As a conventional technology related to what has been described thus far, a solid-state image-sensing device has been disclosed and proposed, for example, in JP-A-2001-036059 (hereinafter “Patent Document 1). This solid-state image-sensing device is provided with: photoelectric converting means that has a photosensitive element generating an electrical signal commensurate with the amount of incident light and a first transistor whose first electrode is connected to the photosensitive element and that converts the electrical signal natural-logarithmically by operating the first transistor in a subthreshold region; and a guide path that guides an output signal of the photoelectric converting means to an output signal line. The solid-state image-sensing device is further provided with voltage switching means that switches a voltage at a control electrode of the first transistor. Here, the voltage switching means switches the voltage at the control electrode of the first transistor, so that a potential state of the first transistor is reset.

Certainly, in addition to being produced at much lower costs than CCD (charge coupled devices) sensors, the CMOS sensors shown in FIGS. 5 and 6 are built with small circuit elements and operate on a single low voltage. It is for this reason that, in recent years, these CMOS sensors have been used in various applications such as portable phone terminals equipped with cameras, so-called web cameras, and the like.

However, in the conventional CMOS sensor shown in FIG. 5, there is a possibility that, although the capacitor 52 is supposed to be discharged by the detection current ix when the photodiode 51 is exposed to light, the terminal voltage Vc of the capacitor 52 does not fall adequately. Likewise, in the conventional CMOS sensor shown in FIG. 6, there is a possibility that, although the capacitor 62 is supposed to be charged by the detection current ix when the photodiode 61 is exposed to light, the terminal voltage Vc of the capacitor 62 does not rise adequately.

The above-described problems result from the impossibility of making the most of the detection current ix for discharging of the capacitor 52 and charging of the capacitor 62 due to leakage of electric charge from the switches 54 and 55 or the switches 64 and 65, of which each is built with a field-effect transistor (subthreshold leakage by which the current flows through the channel when the switch is off, or junction leakage by which the current flows between the source and the drain to the substrate).

Needless to say, the above-described leakage does not have significant effect on the received optical signal as long as the photodiodes 51 and 61 receive an amount of light large enough to produce a sufficiently large detection current ix. However, consider a case where pictures are taken in a dark place, for example. In this case, such leakage cannot be ignored because the obtained detection current ix is extremely weak. This undesirably results in a reduction in responsivity to light and deterioration in the S/N ratio of the received optical signal.

To avoid this, in the conventional CMOS sensors, circuit elements are ingeniously structured in the fabrication process so as to reduce the above-described leakage. However, this does not provide a drastic solution, and disadvantageously increases the costs of devices.

Incidentally, in the conventional technology disclosed in Patent Document 1, since a diffusion region (the source/drain) of the field-effect transistor is connected between the anode of the photodiode and the direct-current voltage line, leakage of that transistor may arise the same problems as described above.

### SUMMARY OF THE INVENTION

In view of the conventionally experienced problems described above, an object of the present invention is to provide photoelectric conversion circuits that can enhance responsivity to light and improve the S/N ratio of a received optical signal by making the most of electric power obtained from a photoelectric conversion element, and to provide solid-state image-sensing devices using such photoelectric conversion circuits.

To achieve the above object, according to one aspect of the present invention, a photoelectric conversion circuit is provided with: a photoelectric conversion element that generates a detection current commensurate with the amount of light received thereby; a capacitor having one end connected to one end of the photoelectric conversion element, the one end of the capacitor from which a terminal voltage commensurate with the integral of the detection current is drawn; and an amplifier that receives the terminal voltage of the capacitor and generates an amplified signal commensurate with the terminal voltage thus received. Here, the photoelectric conversion circuit outputs a final optical signal by using the amplified signal of the amplifier. As a current path that can serve as a charging/discharging path of the capacitor, the photoelectric conversion circuit includes only a current path along which the photoelectric conversion element is located.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a block diagram showing an embodiment of a solid-state image-sensing device according to the invention;

FIG. 2 is a diagram illustrating the broader concept of the circuit configuration of a pixel sensor Pmn;

FIG. 3 is a circuit diagram showing a first embodiment of the pixel sensor Pmn;

FIG. 4 is a circuit diagram showing a second embodiment of the pixel sensor Pmn;

FIG. 5 is a circuit diagram showing an example of a conventional CMOS photoelectric conversion circuit; and

FIG. 6 is a circuit diagram showing another example of a conventional CMOS photoelectric conversion circuit.

### DETAILED DESCRIPTION OF PREFERRED EMBODIMENTS

Hereinafter, as an example of implementation, a description will be given of a case where a photoelectric conversion circuit embodying the present invention is used as a photosensitive portion (a pixel sensor) of a solid-state image-sensing device incorporated in portable phone terminals equipped with cameras, web cameras, and the like.

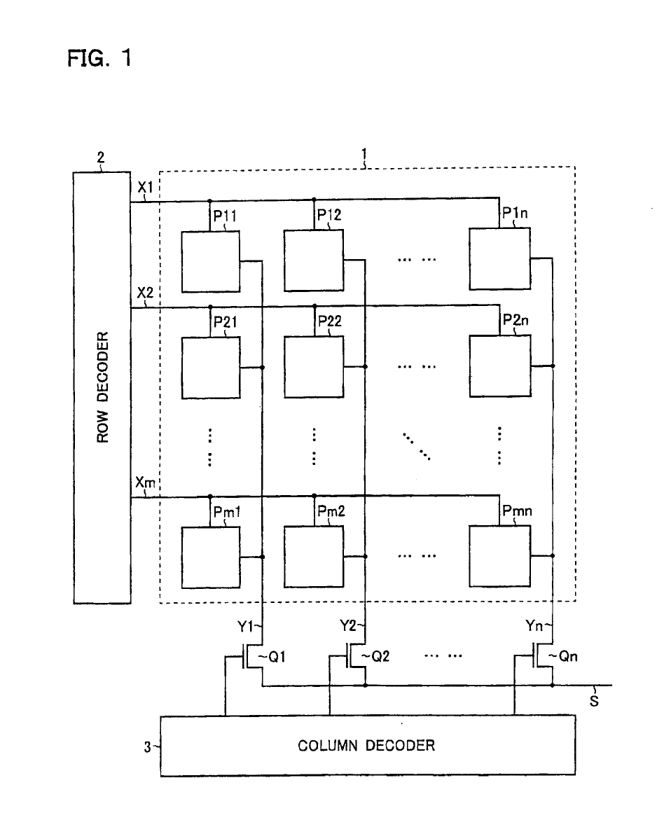

FIG. 1 is a block diagram showing an embodiment of a solid-state image-sensing device according to the invention.

As shown in this figure, the solid-state image-sensing device of this embodiment includes a sensor array 1, a row decoder 2, and a column decoder 3.

The sensor array 1 is composed of row selection lines X1 to Xm laid in the horizontal direction and column selection lines Y1 to Yn laid in the vertical direction, and has m×n (where m and n are integers equal to or greater than 2) pixel sensors P11 to Pmn at points where the row and column selection lines intersect, the pixel sensors P11 to Pmn being arranged in a two-dimensional matrix. Though not shown in FIG. 1, in addition to the above-described row selection lines X1 to Xm and column selection lines Y1 to Yn, a power supply voltage line, a ground voltage line, different clock lines, a bias voltage line, and the like, are connected to the sensor array 1, The configuration and operation of the pixel sensors P11 to Pmn to which the present invention is applied will be described later in detail.

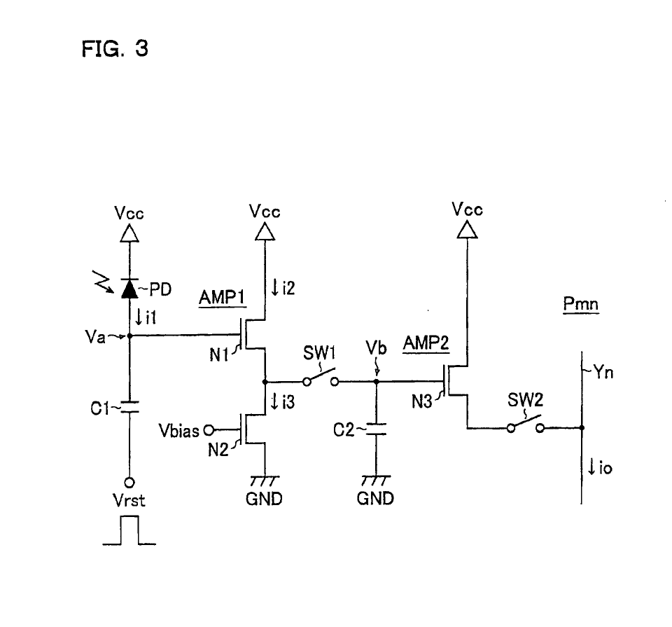

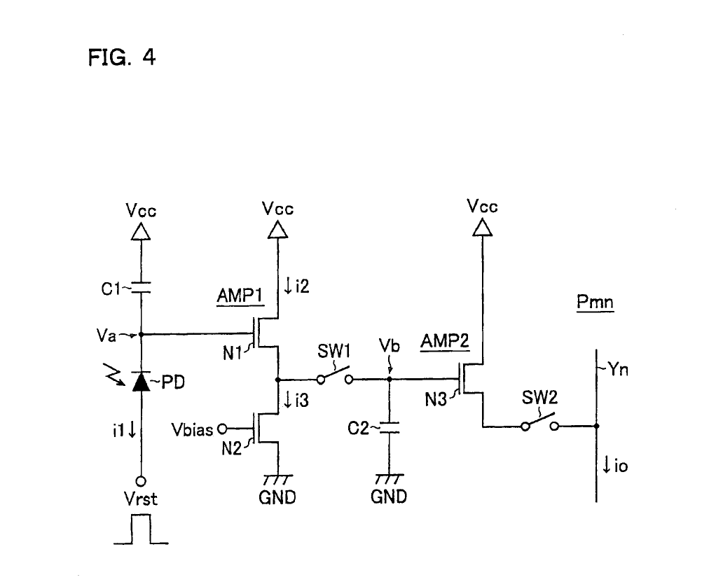

The row decoder 2 performs a vertical scanning of the sensor array 1 by controlling via the row selection lines X1 to Xm the opening and closing of a row selection switch (corresponding to a switch SW2 shown in FIGS. 3 and 4, which will be described later) provided one for each of the pixel sensors P11 to Pmn.

The column decoder 3 performs a horizontal scanning of the sensor array 1 by controlling the opening and closing of column selection switches Q1 to Qn provided one for each of the column selection lines Y1 to Yn. The column selection switches Q1 to Qn, of which each is built with an N-channel field-effect transistor, are each connected at the drain thereof to corresponding one of the column selection lines Y1 to Yn, connected at the source thereof to an output line S through which a final optical signal is outputted, and connected at the gate thereof to the column decoder 3.

Next, the configuration and operation of the pixel sensor Pmn to which the present invention is applied will be described in detail.

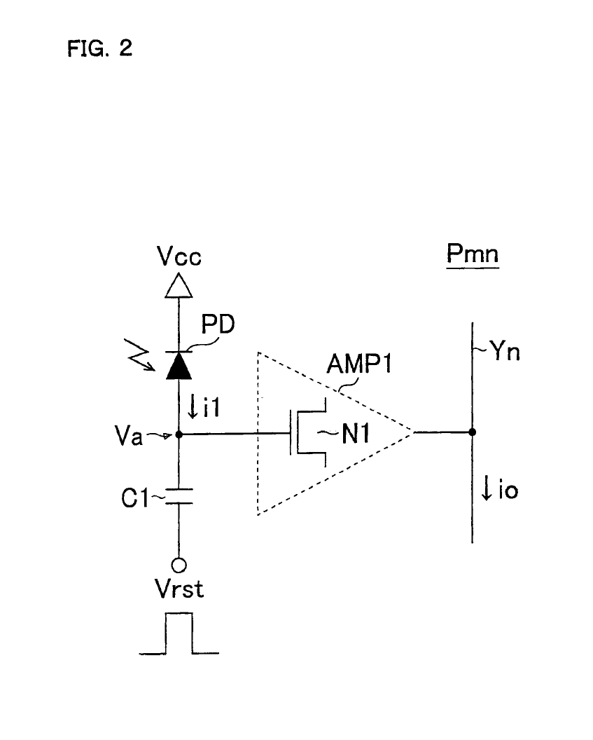

FIG. 2 is a diagram illustrating the broader concept of the circuit configuration of the pixel sensor Pmn.

As shown in this figure, the pixel sensor Pmn to which the present invention is applied includes: a photodiode PD that produces a detection current i1 commensurate with the amount of light received thereby; a capacitor C1 having one end connected to one end (in this figure, the anode) of the photodiode PD, the one end of the capacitor C1 from which a terminal voltage Va commensurate with the integral of the detection current i1 is drawn; and an amplifier AMP1 (for example, a source follower circuit built with a transistor N1) that receives the terminal voltage Va of the capacitor C1 and generates an amplified signal commensurate with the terminal voltage Va thus received. The pixel sensor Pmn is a photoelectric conversion circuit that outputs a final optical signal (an output current io) by using the amplified signal of the amplifier AMP1. As a current path that can serve as a charging/discharging path of the capacitor C1, the pixel sensor Pmn includes only a current path along which the photodiode PD is located.

In other words, to prevent leakage that interferes with charging/discharging of the capacitor C1 on the circuit level, the pixel sensor Pmn to which the present invention is applied is configured as follows. Any diffusion region (i.e., the source/drain of a field-effect transistor) other than the diffusion region (anode/cathode) of the photodiode PD is not connected to one end of the capacitor C1 through which the detection current i1 is passed, and the terminal voltage Va drawn from that one end of the capacitor C1 is received by the gate of the field-effect transistor N1, so that a high impedance is given to that one end of the capacitor C1.

To achieve charging and discharging of the capacitor C1 without connecting the diffusion region (the source/drain) of the field-effect transistor to a line along which the electric charge generated by the photodiode PD is transmitted, in the pixel sensor Pmn configured as described above, any one of a predetermined power supply voltage Vcc and a pulse voltage Vrst that shifts between two different voltage levels is applied to any one of the other end (in this figure, the cathode) of the photodiode PD and the other end of the capacitor C1. As a result, charging/discharging of the capacitor C1 is switched according to the voltage level of the pulse voltage Vrst.

Next, initialization operation and exposure operation of the pixel sensor Pmn configured as described above will be described in detail.

When the pixel sensor Pmn configured as described above is initialized, the pulse voltage Vrst is shifted from a low level (for example, a ground voltage GND) to a high level (for example, a power supply voltage Vcc plus a forward voltage drop Vf of the photodiode PD), so that the terminal voltage Va of the capacitor C1 (the anode voltage of the photodiode PD) is increased by an increase in the pulse voltage Vrst. As a result, since the photodiode PD is biased in the forward direction, the electric charge accumulated in the capacitor C1 is discharged through the power supply voltage line via the photodiode PD. Thereafter, when the pulse voltage Vrst is turned back to a low level, the terminal voltage Va of the capacitor C1 drops to a predetermined initial voltage level (for example, a ground voltage GND) (that is, an initial state).

However, the high level potential and the low level potential of the pulse voltage Vrst are not limited to those specifically described above.

For example, in a case where the electric charge accumulated in the capacitor C1 is not necessarily fully discharged, the high level potential of the pulse voltage Vrst may be a potential lower than the example specifically described above (for example, a power supply voltage Vcc). However, to make the most of the capacitance of the capacitor C1 by fully discharging the electric charge accumulated in the capacitor C1, it is preferable that, as described above, a potential that is higher than the power supply voltage Vcc by the forward voltage drop Vf be set as the high level potential of the pulse voltage Vrst.

Additionally, by setting the low level potential of the pulse voltage Vrst, not to the ground voltage GND, but to a potential that is slightly lower than the on threshold voltage of the transistor N1, it is possible to turn the transistor N1 on by the passage of an extremely weak detection current i1 at the time of exposure of the photodiode PD. This helps increase responsivity to extremely weak light.

After initialization of the pixel sensor Pmn, when the photodiode PD is exposed to light, the pulse voltage Vrst is kept at a low level, and the detection current i1 commensurate with the amount of received light is generated by the photodiode PD. As a result, the capacitor C1 is charged by the detection current i1 fed from the photodiode PD, so that the terminal voltage Va rises above the initial voltage level. The amplifier AMP1 then generates an amplified voltage commensurate with the resultant terminal voltage Va. In this way, a final optical signal (an output current io) is outputted.

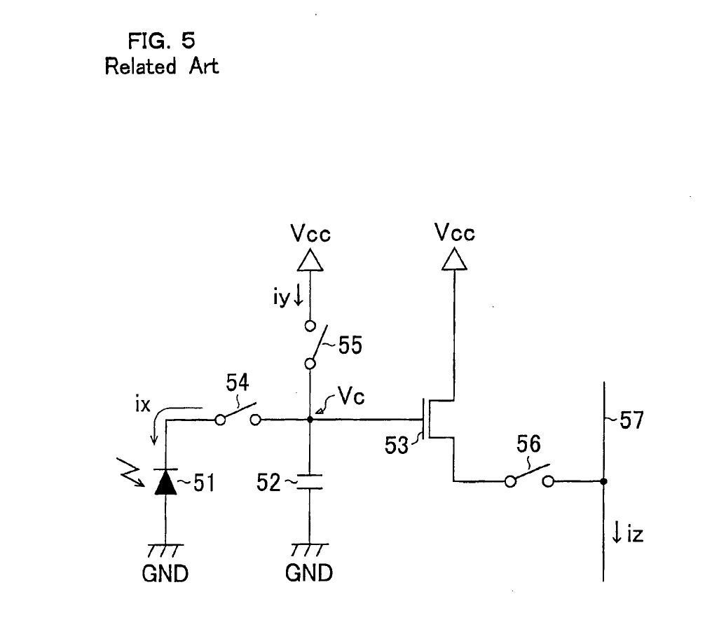

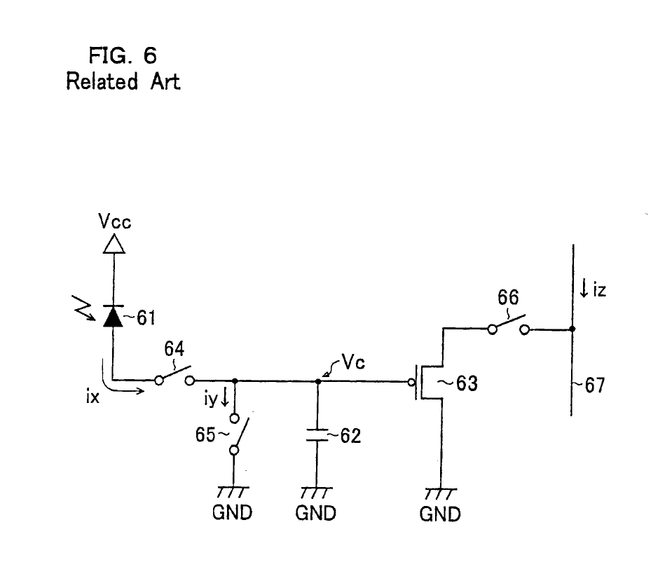

As described above, with the pixel sensor Pmn to which the present invention is applied, unlike the conventional photoelectric conversion circuits shown in FIGS. 5 and 6, no diffusion region (the source/drain) of the field-effect transistor is connected to the one end of the capacitor C1 through which the detection current i1 is passed. This makes it possible to make the most of the electric power obtained from the photodiode PD with no consideration given to the leakage thereof, and hence enhance responsivity to light and improve the S/N ratio of a received optical signal. Furthermore, the pixel sensor Pmn to which the present invention is applied gets along well with a logic device for general-purpose process, making it easy to combine them on a single chip.

Next, with reference to FIG. 3, the configuration and operation of the pixel sensor Pmn to which the present invention is applied will be described more specifically.

FIG. 3 is a circuit diagram showing a first embodiment of the pixel sensor Pmn (a cathode common type).

As shown in this figure, the pixel sensor Pmn of this embodiment includes a photodiode PD, capacitors C1 and C2, N-channel field-effect transistors N1 to N3, and switches SW1 and SW2.

The cathode of the photodiode PD is connected to a point to which the power supply voltage Vcc is applied, and the anode thereof is connected to one end of the capacitor C1 and to the gate of the transistor N1. The other end of the capacitor C1 is connected to a point to which the pulse voltage Vrst is applied. The drain of the transistor N1 is connected to a point to which the power supply voltage Vcc is applied. The source of the transistor N1 is connected to the drain of the transistor N2 and to one end of the switch SW1. The source of the transistor N2 is connected to the ground, and the gate thereof is connected to a point to which a bias voltage Vbias is applied. The other end of the switch SW1 is connected to one end of the capacitor C2 and to the gate of the transistor N3. The other end of the capacitor C2 is connected to the ground. The drain of the transistor N3 is connected to a point to which the power supply voltage Vcc is applied, and the source thereof is connected to one end of the switch SW2. The other end of the switch SW2 is connected to the column selection line Yn.

When the pixel sensor Pmn configured as described above is initialized, the switches SW1 and SW2 are both turned on.

As mentioned above, when the pixel sensor Pmn configured as described above is initialized, the pulse voltage Vrst is shifted from a low level to a high level, so that the terminal voltage Va of the capacitor C1 is increased by an increase in the pulse voltage Vrst. As a result, since the photodiode PD is biased in the forward direction, the electric charge accumulated in the capacitor C1 is discharged through the power supply voltage line via the photodiode PD. Thereafter, when the pulse voltage Vrst is turned back to a low level, the terminal voltage Va of the capacitor C1 drops to a predetermined initial voltage level (for example, a ground voltage GND).

At this point, since the transistor N1 is reset to its initial state (off state), the feeding of a charging current i2 from the transistor N1 to the capacitor C2 is stopped. On the other hand, the transistor N2 serves as a constant current source that continuously draws a fixed amount of discharging current i3 from the capacitor C2 according to the predetermined bias voltage Vbias applied to the gate thereof. As a result, the electric charge accumulated in the capacitor C2 is discharged through the ground line via the switch SW1 and the transistor N2, so that a terminal voltage Vb of the capacitor C2 drops to a predetermined initial voltage level (that is, a ground voltage GND). As a result, the transistor N3 is reset to its initial state (off state), and an output current io flowing through the column selection line Yn via the switch SW2 is reduced to a minimum value (zero).

That is, in the pixel sensor Pmn configured as described above, when the pulse voltage Vrst is shifted from a low level to a high level, the capacitor C1 is discharged, and, thereafter, when the pulse voltage Vrst is turned back to a low level, the capacitor C2 is discharged.

On the other hand, after initialization of the pixel sensor Pmn, when the photodiode PD is exposed to light, the switch SW1 is turned on and the switch SW2 is turned off.

As mentioned above, when the pixel sensor Pmn configured as described above is exposed to light, the pulse voltage Vrst is kept at a low level, and the detection current i1 commensurate with the amount of received light is generated by the photodiode PD. As a result, the capacitor C1 is charged by the detection current i1 fed from the photodiode PD, so that the terminal voltage Va of the capacitor C1 rises above the initial voltage level. Thus, depending on the amount of light received by the photodiode PD, the conductivity of the transistor N1 becomes higher than that observed in its initial state. This makes the transistor N1 feed to the capacitor C2 the charging current i2 obtained by amplifying the detection current i1.

Thus, the capacitor C2 is charged by a difference current (i2-i3) obtained by subtracting the discharging current i3 of the transistor N2 from the charging current i2 of the transistor N1, so that the terminal voltage Vb of the capacitor C2 rises above the initial voltage level. As a result, depending on the amount of light received by the photodiode PD, the conductivity of the transistor N3 becomes higher than that observed in its initial state.

After the photodiode PD is exposed to light, when the received optical signal is read, the switch SW1 is turned off and the switch SW2 is turned on. As a result of this switching control, the output current io commensurate with the conductivity of the transistor N3 (that is, the amount of light received by the photodiode PD) is outputted through the column selection line Yn. This makes it possible to detect the amount of light received by the photodiode PD based on an increase in the output current io.

As described above, the pixel sensor Pmn of this embodiment includes: the photodiode PD whose cathode is connected to a point to which the power supply voltage Vcc is applied, the photodiode PD producing the detection current i1 commensurate with the amount of light received thereby; the capacitor C1 having one end connected to the anode of the photodiode PD and the other end connected to a point to which the pulse voltage Vrst that shifts between two different voltage levels is applied, the one end of the capacitor C1 from which the terminal voltage Va commensurate with the integral of the detection current i1 is drawn; and a current output amplifier AMP1 (a source follower circuit built with the transistor N1) that receives the terminal voltage Va of the capacitor C1 and generates an amplified current (a charging current i2) commensurate with the terminal voltage Va thus received. The pixel sensor Pmn is a photoelectric conversion circuit that outputs a final optical signal (an output current io) by using the amplified current (a charging current i2) of the current output amplifier AMP1. The anode of the photodiode PD is connected only to the one end of the capacitor C1 and to an input terminal of the current output amplifier AMP1 (the gate of the transistor N1), so that charging/discharging of the capacitor C1 is switched according to the voltage level of the pulse voltage Vrst. With this configuration, as is the case with the configuration whose broader concept has been explained by using FIG. 2, it is possible to make the most of the electric power obtained from the photodiode PD, and hence enhance responsivity to light and improve the S/N ratio of a received optical signal.

In the pixel sensor Pmn of this embodiment, the current output amplifier AMP1 is configured as a source follower circuit built with a field-effect transistor N1 having a gate to which the terminal voltage Va of the capacitor C1 is inputted and a source from which an amplified current (a charging current i2) is drawn. With this configuration, it is possible to realize a current output amplifier AMP1 that has a very simple and compact structure.

The pixel sensor Pmn of this embodiment includes: the switch SW1 connected at one end thereof to an output terminal of the current output amplifier AMP1 (the source of the transistor N1); the constant current source (the transistor N2) connected between the output terminal of the current output amplifier AMP1 and the ground, the constant current source drawing a predetermined constant current (a discharging current i3); the capacitor C2 having one end connected to the other end of the switch SW1 and the other end connected to the ground, the one end of the capacitor C2 from which the terminal voltage Vb commensurate with the integral of a current (a difference current (i2-i3)) flowing into the capacitor C2 from that one end is drawn; a current output amplifier AMP2 (a source follower circuit built with the transistor N3) that receives the terminal voltage Vb of the capacitor C2 and generates an amplified current (an output current io) commensurate with the terminal voltage Vb thus received; and the switch SW2 connected between an output terminal of the current output amplifier AMP2 (the source of the transistor N3) and the output line (the column selection line Yn).

With this configuration, by changing the discharging current i3 drawn into the transistor N2, it is possible to appropriately adjust the difference current (i2-i3) fed to the capacitor C2. That is, it is possible to adjust the responsivity of the pixel sensor Pmn according to the bias voltage Vbias.

The pixel sensor Pmn of this embodiment is so configured as to produce an output current io by integrating the detection current i1 of the photodiode PD by using the capacitors C1 and C2. This makes it possible to remove a fluctuation component and a noise component of the light source.

Incidentally, in the pixel sensor Pmn of this embodiment, the switch SW1 is connected to one end of the capacitor C2. Thus, in a case where the switch SW1 is built with a field-effect transistor, some leakage inevitably occurs. However, since the charging current i2 produced by the transistor N1 and the discharging current i3 produced by the transistor N2 are sufficiently larger than a leakage current from the switch SW1, the influence thereof becomes almost negligible.

With a solid-state image-sensing device built with a plurality of the pixel sensors Pmn of this embodiment, it is possible to adopt a method (a so-called global shutter mode) in which all the pixel sensors are exposed to light with identical timing, and then the optical signals obtained by them are read sequentially. This makes it possible to take an image of a moving object without suffering from blurring or distortion.

Instead of a global shutter mode, if a rolling shutter mode in which the pixel sensors are exposed to light with different timing from line to line is adopted, the capacitor C2, the transistor N3, and the switch SW do not necessarily have to be used. In this case, it is possible to connect the output terminal of the current output amplifier AMP1 (the source of the transistor N1) directly to the column selection line Yn via the switch SW1.

The embodiment described above deals with a case in which the present invention is applied to a two-dimensional matrix CMOS image sensor. This, however, is not meant to limit the application of the invention in any way; the invention finds wide application in solid-state image-sensing devices of any other types (photodetectors, line sensors, area sensors, and the like).

The invention may be practiced in any other manner than specifically described above, with any modification or variation made within the spirit of the invention.

For example, the embodiment described above deals with a case in which the pixel sensor Pmn has a configuration in which the cathode of the photodiode PD is connected to a common power supply point (a so-called cathode common type). However, the present invention is not limited to this specific configuration, but may be so implemented that, as shown in FIG. 4, the anode of the photodiode PD is connected to a common point (in FIG. 4, a point to which the pulse voltage Vrst is applied) (a so-called anode common type).

That is, as a second embodiment of the pixel sensor Pmn to which the present invention is applied, as shown in FIG. 4, the pixel sensor Pmn may include: a photodiode PD whose anode is connected to a point to which a pulse voltage Vrst that shifts between two different voltage levels is applied, the photodiode PD producing a detection current i1 commensurate with the amount of light received thereby; a capacitor C1 having one end connected to the cathode of the photodiode PD and the other end connected to a point to which a predetermined power supply voltage Vcc is applied, the one end of the capacitor C1 from which a terminal voltage Va commensurate with the integral of the detection current i1 is drawn; a current output amplifier AMP1 (a source follower circuit built with a transistor N1) that receives the terminal voltage Va of the capacitor C1 and generates an amplified current (a charging current i2) commensurate with the terminal voltage Va thus received. The pixel sensor Pmn is a photoelectric conversion circuit that outputs a final optical signal (an output current io) by using the amplified current (a charging current i2) of the current output amplifier AMP1. The cathode of the photodiode PD is connected only to the one end of the capacitor C1 and to an input terminal of the current output amplifier AMP1 (the gate of the transistor N1), so that charging/discharging of the capacitor C1 is switched according to the voltage level of the pulse voltage Vrst. With this configuration, as is the case with the first embodiment described above, it is possible to make the most of the electric power obtained from the photodiode PD, and hence enhance responsivity to light and improve the S/N ratio of a received optical signal.

The embodiments described above deal with cases in which a photodiode is used as a photoelectric conversion element; however, it is also possible to use instead a photoelectric conversion element such as a phototransistor or an organic photoelectric conversion film.

The embodiments described above deal with cases in which a source follower circuit built with a transistor N1 is used as a current output amplifier AMP1; however, it is also possible to use instead an operational amplifier or the like. With this configuration, it is possible to further enhance the detection accuracy and sensitivity.

The invention offers the following advantages: it helps realize photoelectric conversion circuits that can enhance responsivity to light and improve the S/N ratio of a received optical signal by making the most of electric power obtained from a photoelectric conversion element; hence, it helps realize solid-state image-sensing devices using such photoelectric conversion circuits.

In terms of industrial applicability, the invention is useful in enhancing light responsivity of solid-state image-sensing devices incorporated in portable phone terminals equipped with cameras, web cameras, and the like, and improving the S/N ratio of an optical signal received by such solid-state image-sensing devices.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A photoelectric conversion circuit comprising:
a photoelectric conversion element that generates a detection current commensurate with an amount of light received thereby;
a capacitor having one end connected to one end of the photoelectric conversion element, the one end of the capacitor from which a terminal voltage commensurate with an integral of the detection current is drawn; and
an amplifier that receives the terminal voltage of the capacitor and generates an amplified signal commensurate with the terminal voltage thus received,
wherein the photoelectric conversion circuit outputs a final optical signal by using the amplified signal of the amplifier,
wherein, as a current path that can serve as a charging/discharging path of the capacitor, the photoelectric conversion circuit includes only a current path along which the photoelectric conversion element is located.

2. The photoelectric conversion circuit of claim 1,
wherein any one of a predetermined power supply voltage and a pulse voltage that shifts between two different voltage levels is applied to any one of another end of the photoelectric conversion element and another end of the capacitor,
wherein charging/discharging of the capacitor is switched according to a voltage level of the pulse voltage.

3. A photoelectric conversion circuit comprising:
a photodiode whose cathode is connected to a point to which a predetermined power supply voltage is applied, the photodiode producing a detection current commensurate with an amount of light received thereby;
a capacitor having one end connected to an anode of the photodiode and another end connected to a point to which a pulse voltage that shifts between two different voltage levels is applied, the one end of the capacitor from which a terminal voltage commensurate with an integral of the detection current is drawn; and
a current output amplifier that receives the terminal voltage of the capacitor and produces an amplified current commensurate with the terminal voltage thus received,
wherein the photoelectric conversion circuit outputs a final optical signal by using the amplified current of the current output amplifier,
wherein the anode of the photodiode is connected only to the one end of the capacitor and to an input terminal of the current output amplifier,
wherein charging/discharging of the capacitor is switched according to a voltage level of the pulse voltage.

4. The photoelectric conversion circuit of claim 3, wherein
the current output amplifier is a source follower circuit built with a field-effect transistor having a gate to which the terminal voltage of the capacitor is inputted and a source from which the amplified current is drawn.

5. The photoelectric conversion circuit of claim 3, further comprising:
a first switch connected at one end thereof to an output terminal of the current output amplifier;
a constant current source connected between the output terminal of the current output amplifier and a ground, the constant current source drawing a predetermined constant current;
a second capacitor having one end connected to another end of the first switch and another end connected to the ground, the one end of the second capacitor from which a second terminal voltage commensurate with an integral of a current flowing into the second capacitor from that one end is drawn;
a second current output amplifier that receives the second terminal voltage of the second capacitor and produces a second amplified current commensurate with the second terminal voltage thus received; and
a second switch connected between an output terminal of the second current output amplifier and an output line.

6. A photoelectric conversion circuit comprising:
a photodiode whose anode is connected to a point to which a pulse voltage that shifts between two different voltage levels is applied, the photodiode producing a detection current commensurate with an amount of light received thereby;
a capacitor having one end connected to a cathode of the photodiode and another end connected to a point to which a predetermined power supply voltage is applied, the one end of the capacitor from which a terminal voltage commensurate with an integral of the detection current is drawn; and
a current output amplifier that receives the terminal voltage of the capacitor and produces an amplified current commensurate with the terminal voltage thus received;
wherein the photoelectric conversion circuit outputs a final optical signal by using the amplified current of the current output amplifier,
wherein the cathode of the photodiode is connected only to the one end of the capacitor and to an input terminal of the current output amplifier,
wherein charging/discharging of the capacitor is switched according to a voltage level of the pulse voltage.

7. The photoelectric conversion circuit of claim 6, wherein
the current output amplifier is a source follower circuit built with a field-effect transistor having a gate to which the terminal voltage of the capacitor is inputted and a source from which the amplified current is drawn.

8. The photoelectric conversion circuit of claim 6, further comprising:
a first switch connected at one end thereof to an output terminal of the current output amplifier;
a constant current source connected between the output terminal of the current output amplifier and a ground, the constant current source drawing a predetermined constant current;
a second capacitor having one end connected to another end of the first switch and another end connected to the ground, the one end of the second capacitor from which a second terminal voltage commensurate with an integral of a current flowing into the second capacitor from that one end is drawn;
a second current output amplifier that receives the second terminal voltage of the second capacitor and produces a second amplified current commensurate with the second terminal voltage thus received; and
a second switch connected between an output terminal of the second current output amplifier and an output line.

9. A solid-state image-sensing device having a photosensitive portion, wherein
the photosensitive portion comprises the photoelectric conversion circuit of one of claims 1 to 8.

10. A solid-state image-sensing device having a photosensitive portion,
wherein the photosensitive portion comprises a plurality of the photoelectric conversion circuits of claim 5 or 8,
wherein, after all the photoelectric conversion circuits are exposed to light with identical timing, optical signals obtained by the photoelectric conversion circuits are read sequentially.
